(19) United States
(12) Patent Application Publication
(10) Pub. No.: US 2023/0253558 A1
(43) Pub. Date: Aug. 10, 2023

(54) NEGATIVE ELECTRODE LAYER AND ALL-SOLID STATE BATTERY

(71) Applicants: TOYOTA JIDOSHA KABUSHIKI KAISHA, Toyota-shi (JP); Panasonic Holdings Corporation, Osaka (JP); UBE Corporation, Ube-shi (JP)

(72) Inventors: Akio MITSUI, Anjo-shi (JP); Yasunari SUGITA, Osaka (JP); Takaaki TAMURA, Osaka (JP); Shinichirou OOTANI, Ube-shi (JP)

(21) Appl. No.: 18/163,924

(22) Filed: Feb. 3, 2023

(30) Foreign Application Priority Data
Feb. 7, 2022 (JP) 2022-017013

(51) Int. Cl. H01M 4/485; H01M 4/62; H01M 10/0562; H01M 10/0585

(52) U.S. Cl. CPC H01M 4/485; H01M 4/62; H01M 10/0562; H01M 10/0585; H01M 2004/027

(57) ABSTRACT

There is provided a negative electrode layer that is used in an all-solid state battery, containing lithium titanate and a sulfide solid electrolyte, in which a moisture amount contained in the lithium titanate is 25 ppm or more and 547 ppm or less.

### CROSS-REFERENCE TO RELATED APPLICATION

This application claims priority to Japanese Patent Application No. 2022-017013 filed on Feb. 7, 2022, incorporated herein by reference in its entirety.

### BACKGROUND

### 1. Technical Field

The present disclosure relates to a negative electrode layer and an all-solid state battery.

### 2. Description of Related Art

An all-solid state battery is a battery having a solid electrolyte layer between a positive electrode layer and a negative electrode layer, and it has the advantage that a safety device can be easily simplified as compared with a liquid-based battery having an electrolytic solution containing a flammable organic solvent. For example, Japanese Unexamined Patent Application Publication No. 2021-128885 (JP 2021-128885 A) discloses a negative electrode for an all-solid state battery, containing a titanium oxide and a sulfide solid electrolyte. In addition, Japanese Unexamined Patent Application Publication No. 2021-072259 (JP 2021-072259 A) discloses an all-solid state battery including a positive electrode layer, a solid electrolyte layer, and a negative electrode layer, in which the positive electrode layer contains a positive electrode active material, a conductive material, and an oxide lithium ion conductor (for example, lithium titanate), and a sulfide solid electrolyte. Further, Japanese Unexamined Patent Application Publication No. 2019-106352 (JP 2019-106352 A) discloses a production method for a sulfide solid state battery, including a step of doping lithium titanate with lithium to obtain a pre-doped material and a step of mixing a sulfide solid electrolyte, a silicon-based active material, and the pre-doped material to obtain a negative electrode mixture.

### SUMMARY

From the viewpoint of improving the performance of an all-solid state battery, a negative electrode layer having a low charging resistance (in terms of resistance during charging) is demanded. The present disclosure provides a negative electrode layer and an all-solid state battery having a low charging resistance.

A first aspect of the present disclosure relates to a negative electrode layer. The negative electrode layer that is used in an all-solid state battery contains lithium titanate and a sulfide solid electrolyte, and the amount of the moisture contained in the lithium titanate is 25 ppm or more and 547 ppm or less.

According to the first aspect of the present disclosure, since the amount of the moisture contained in lithium titanate is within a predetermined range, a negative electrode layer having low charging resistance can be obtained.

In the negative electrode layer according to the first aspect, the lithium titanate may have a composition represented by Li₄Ti₅O₁₂.

In the negative electrode layer according to the first aspect, the specific surface area of the lithium titanate may be 3.9 m²/g or more and 6.5 m²/g or less.

In the negative electrode layer according to the first aspect, the sulfide solid electrolyte may contain Li, P, and S.

In the negative electrode layer according to the first aspect, the proportion of the lithium titanate to the total of the lithium titanate and the sulfide solid electrolyte may be 40% by volume or more and 80% by volume or less.

A second aspect of the present disclosure relates to an all-solid state battery having a positive electrode layer, a negative electrode layer, and a solid electrolyte layer arranged between the positive electrode layer and the negative electrode layer.

According to the second aspect of the present disclosure, since the negative electrode layer is used, an all-solid state battery having a low charging resistance can be obtained.

According to the aspects of the present disclosure, it is possible to provide a negative electrode layer and an all-solid state battery having a low charging resistance.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic cross-sectional view exemplarily illustrating an all-solid state battery in the present disclosure; and

FIG. 2 is a graph showing the relationship between the moisture amount of the negative electrode active material and the charging resistance ratio in Examples 1 to 6 and Comparative Examples 1 to 6.

### DETAILED DESCRIPTION OF EMBODIMENTS

Hereinafter, a negative electrode layer and an all-solid state battery in the present disclosure will be described in detail.

A. Negative Electrode Layer

The negative electrode layer in the present disclosure contains lithium titanate and a sulfide solid electrolyte, and the amount of the moisture contained in the lithium titanate is 25 ppm or more and 547 ppm or less. In addition, the negative electrode layer in the present disclosure is used in an all-solid state battery.

According to the present disclosure, since the amount of the moisture contained in lithium titanate is within a predetermined range, a negative electrode layer having a low charging resistance is obtained. For example, in a case where the amount of the moisture contained in lithium titanate is large, the moisture reacts with the sulfide solid electrolyte, which causes the deterioration of the sulfide solid electrolyte (the generation of a high resistance layer). As a result, the charging resistance of the negative electrode layer becomes high. On the other hand, in the present disclosure, since the amount of the moisture contained in lithium titanate is equal to or smaller than a predetermined value, the deterioration of the sulfide solid electrolyte (the generation of a high resistance layer) can be suppressed, and the charging resistance of the negative electrode layer can be reduced.

On the other hand, from the viewpoint of suppressing the deterioration of the sulfide solid electrolyte, it is preferable to reduce the amount of the moisture contained in lithium titanate as small as possible. However, when the inventors of the present disclosure examined in detail the relationship between the amount of the moisture contained in lithium titanate and the charging resistance, the obtained result was that, surprisingly, the charging resistance of the negative electrode layer increases in a case the amount of the moisture contained in lithium titanate is extremely reduced. Although the reason for the result is not completely revealed, the influence of the electrification characteristics (the zeta potentials) of the lithium titanate and the sulfide solid electrolyte is presumed to be involved.

Specifically, the electrification characteristic of the surface of the lithium titanate is positive, and the electrification characteristic of the surface of the sulfide solid electrolyte is also positive. As a result, it is presumed that the lithium titanate and the sulfide solid electrolyte repel each other in a case where the moisture amount is low. On the other hand, in the present disclosure, it is presumed that the presence of an appropriate amount of the moisture on the surface of the lithium titanate improves the affinity between the lithium titanate and the sulfide solid electrolyte, which reduces the charging resistance of the negative electrode layer.

1. Lithium Titanate

The negative electrode layer in the present disclosure contains lithium titanate. Lithium titanate functions as a negative electrode active material. The amount of the moisture contained in lithium titanate is generally 25 ppm or more and 547 ppm or less, and it may be 53 ppm or more and 412 ppm or less. In a case where the moisture amount is large, there is a possibility that the deterioration of the sulfide solid electrolyte occurs. On the other hand, in a case where the moisture amount is small, there is a possibility that the lithium titanate and the sulfide solid electrolyte electrically repel each other and thus a good contact state is not obtained. For example, in a case where the amount of the moisture contained in lithium titanate is 25 ppm, 25 μg of moisture is attached to 1 g of the lithium titanate. The moisture amount is defined as the moisture amount obtained in a case where lithium titanate is heated from 25° C. to 300° C. The moisture amount is calculated, for example, by measurement with a Karl Fischer titrator.

Lithium titanate (LTO) is a compound containing Li, Ti, and O. A part of Ti in the lithium titanate may be replaced with another metal element (for example, a transition metal element). Further, a part of Li in the lithium titanate may be replaced with another metal element (for example, an alkali metal element). Lithium titanate may have a crystal phase having a spinel structure.

Examples of the composition of the lithium titanate include LiₓTi_{y}O_{z} (3.5≤x≤4.5, 4.5≤y≤5.5, and 11≤z≤13). x may be 3.7 or more and 4.3 or less, or it may be 3.9 or more and 4.1 or less. y may be 4.7 or more and 5.3 or less, or it may be 4.9 or more and 5.1 or less. z may be 11.5 or more and 12.5 or less, or it may be 11.7 or more and 12.3 or less. Lithium titanate preferably has a composition represented by Li₄Ti₅O₁₂.

Examples of the shape of the lithium titanate include a particle shape. The average particle diameter (Ds₅₀) of the lithium titanate is, for example, 10 nm or more and 50 μm or less, and it may be 100 nm or more and 20 μm or less. The average particle diameter (Ds₅₀) refers to a particle diameter (a median diameter) of 50% accumulation of the cumulative particle size distribution, and the average particle diameter is calculated from, for example, the measurement by a laser diffraction type particle size distribution meter or a scanning electron microscope (SEM).

The specific surface area of the lithium titanate is, for example, 2 m²/g or more and 10 m²/g or less, and it may be 3 m²/g or more and 8 m²/g or less or may be 3.9 m²/g or more and 6.5 m²/g or less. The specific surface area is calculated from the measurement, for example, by a gas adsorption method, such as the BET method.

It is preferable to insert Li into the lithium titanate to exhibit a good electron conductivity. The electron conductivity (25° C.) of the lithium titanate in a state where Li is inserted is, for example, 8.0×10⁻¹ S/cm or more.

The proportion of the lithium titanate in the negative electrode layer is, for example, 20% by volume or more and 80% by volume or less, and it may be 30% by volume or more and 70% by volume or less, or may be 40% by volume or more and 65% by volume or less. In a case where the proportion of the lithium titanate is small, there is a possibility that the volumetric energy density is reduced. On the other hand, in a case where the proportion of the lithium titanate is large, there is a possibility that the ion conduction path is not formed sufficiently.

2. Sulfide Solid Electrolyte

The negative electrode layer in the present disclosure contains a sulfide solid electrolyte. The sulfide solid electrolyte constitutes an ion conduction path in the negative electrode layer. The sulfide solid electrolyte generally contains sulfur (S) as the main component of the anionic elements. The sulfide solid electrolyte contains, for example, Li, A (A is at least one of P, As, Sb, Si, Ge, Sn, B, Al, Ga, and In), and S. A preferably contains at least P, and the sulfide solid electrolyte may contain at least one of Cl, Br, and I as a halogen. Further, the sulfide solid electrolyte may contain O.

The sulfide solid electrolyte may be a glass-based sulfide solid electrolyte, may be a glass-ceramic-based sulfide solid electrolyte, or may be a crystalline sulfide solid electrolyte. In a case where the sulfide solid electrolyte has a crystal phase, examples of the crystal phase include a Thio-LISICON-type crystal phase, an LGPS-type crystal phase, and an argyrodite-type crystal phase.

The composition of the sulfide solid electrolyte is not particularly limited. However, examples thereof include xLi₂S·(100−x)P₂S₅ (70≤x≤80) and yLiI·zLiBr·(100−y−z)(xLi₂S·(1−x)P₂S₅) (0.7≤x≤0.8, 0≤y≤30, 0≤z≤30).

The sulfide solid electrolyte may have a composition represented by the general formula: Li₄₋ₓGe₁₋ₓPₓS₄ (0<x<1). In the above general formula, at least a part of Ge may be substituted with at least one of Sb, Si, Sn, B, Al, Ga, In, Ti, Zr, V, and Nb. In the above general formula, at least a part of P may be substituted with at least one of Sb, Si, Sn, B, Al, Ga, In, Ti, Zr, V, and Nb. In the above general formula, a part of Li may be substituted with at least one of Na, K, Mg, Ca, and Zn. In the above general formula, a part of S may be substituted with a halogen (at least one of F, Cl, Br, and I).

Examples of other compositions of the sulfide solid electrolyte include Li_{7-x-2y}PS_{6-x-y}X_{y}, Li_{8-x-2y}SiS_{6-x-y}X_{y}, and Li_{8-x-2y}GeS_{6-x-y}X_{y}. In the above composition, X is at least one of F, Cl, Br, and I, and x and y respectively satisfy 0≤x and 0≤y.

The sulfide solid electrolyte preferably has high Li ion conductivity. The Li ion conductivity of the sulfide solid electrolyte at 25° C. is, for example, 1×10⁻⁴ S/cm or more, and it is preferably 1×10⁻³ S/cm or more. The sulfide solid electrolyte preferably has high insulating properties. The electron conductivity of the sulfide solid electrolyte at 25° C. is, for example, 10-6 S/cm or less, and it may be 10-8 S/cm or less or may be 10-10 S/cm or less. In addition, examples of the shape of the sulfide solid electrolyte include a particle shape. The average particle diameter (D₅₀) of the sulfide solid electrolyte is, for example, 0.1 μm or more and 50 μm or less.

The proportion of the sulfide solid electrolyte in the negative electrode layer is, for example, 15% by volume or more and 75% by volume or less, and it may be 15% by volume or more and 60% by volume or less. In a case where the proportion of the sulfide solid electrolyte is low, there is a possibility that the ion conduction path is not formed sufficiently. On the other hand, in a case where the proportion of the sulfide solid electrolyte is high, there is a possibility that the volumetric energy density is reduced.

The proportion of the lithium titanate to the total of the lithium titanate and the sulfide solid electrolyte is, for example, 40% by volume or more or 80% by volume or less, and it may be 50% by volume or more and 80% by volume or less or may be 60% by volume or more and 70% by volume or less. In a case where the proportion of the lithium titanate is small, there is a possibility that the volumetric energy density is reduced. On the other hand, in a case where the proportion of the lithium titanate is large, there is a possibility that the ion conduction path is not formed sufficiently.

In the negative electrode layer, the proportion of the total of the lithium titanate and the sulfide solid electrolyte is, for example, 75% by volume or more or 100% by volume or less, and it may be 80% by volume or more and 100% by volume or less or may be 90% by volume or more and 100% by volume or less.

3. Negative Electrode Layer

The negative electrode layer in the present disclosure may contain or may not contain a conductive material. The “conductive material” in the present disclosure refers to a material having an electron conductivity higher than the electron conductivity of the lithium titanate (strictly speaking, the electron conductivity of the lithium titanate in a state where Li is inserted). Examples of the conductive material include a carbon material, a metal particle, and a conductive polymer. Examples of the carbon material include particle-shaped carbon materials, such as acetylene black (AB) and Ketjen black (KB), and fiber-shaped carbon materials, such as carbon fiber, carbon nanotube (CNT), and carbon nanofiber (CNF). The proportion of the conductive material in the negative electrode layer is, for example, 0.1% by volume or more and 10% by volume or less, and it may be 0.3% by volume or more and 10% by volume or less. On the other hand, in a case where the negative electrode layer does not contain a conductive material, the material having the highest electron conductivity in the negative electrode layer is preferably lithium titanate.

The negative electrode layer in the present disclosure may contain a binder. Examples of the binder include fluorine-based binders, such as polyvinylidene fluoride (PVDF) and polytetrafluoroethylene (PTFE) and rubber-based binders, such as acrylate-butadiene rubber (ABR) and styrene-butadiene rubber (SBR). The proportion of the binder in the negative electrode layer is, for example, 1% by volume or more and 20% by volume or less, and it may be 5% by volume or more and 20% by volume or less. The thickness of the negative electrode layer is, for example, 0.1 μm or more and 1,000 μm or less.

A method of manufacturing the negative electrode layer in the present disclosure is not particularly limited. In the present disclosure, it is also possible to provide a method of manufacturing a negative electrode layer, which is a method of manufacturing a negative electrode layer that is used in an all-solid state battery and includes a preparation step of preparing a paste containing lithium titanate having a moisture amount of 25 ppm or more and 547 ppm or less, a sulfide solid electrolyte, and a dispersion medium, a coating step of applying the paste to form a coating layer, and a drying step of drying the coating layer to remove the dispersion medium. The paste may further contain at least one of a conductive material and a binder. The method of applying the paste is not particularly limited, and examples thereof include a blade method. The drying temperature of the coating layer is, for example, 100° C. or lower.

B. All-solid State Battery

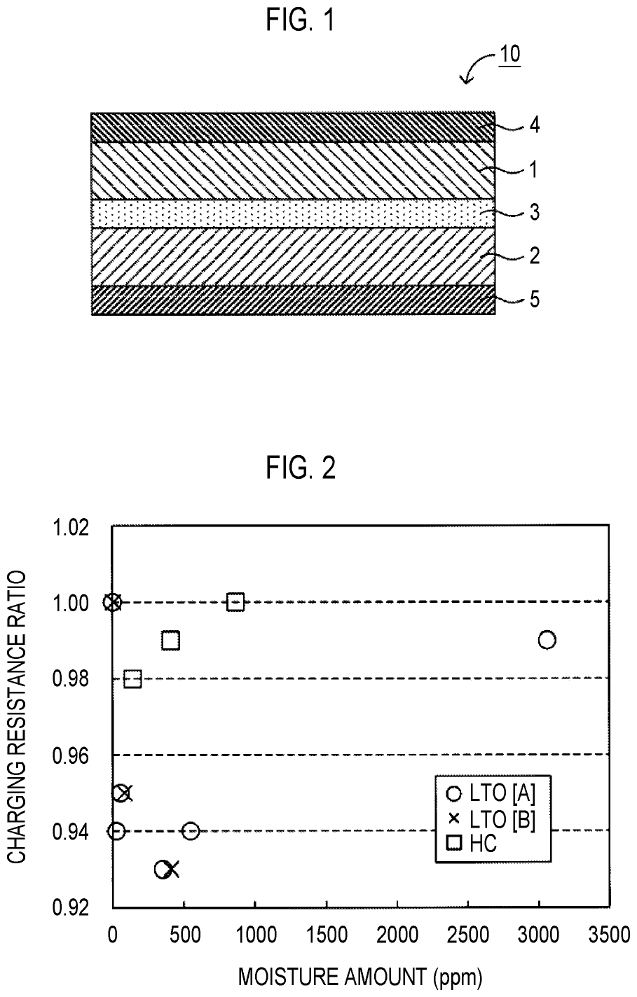

FIG. 1 is a schematic cross-sectional view exemplarily illustrating an all-solid state battery in the present disclosure. An all-solid state battery 10 illustrated in FIG. 1 has a positive electrode layer 1, a negative electrode layer 2, a solid electrolyte layer 3 arranged between the positive electrode layer 1 and the negative electrode layer 2, a positive electrode current collector 4 that collects current from the positive electrode layer 1, and a negative electrode current collector 5 that collects current from the negative electrode layer 2. In the present disclosure, the negative electrode layer 2 is the negative electrode layer described in “A. Negative Electrode Layer” described above.

According to the present disclosure, since the above-described negative electrode layer is used, an all-solid state battery having a low charging resistance is obtained.

1. Negative Electrode Layer

Since the negative electrode layer in the present disclosure is the same as that described in “A. Negative Electrode Layer” described above, the description thereof is omitted here.

2. Positive Electrode Layer

The positive electrode layer in the present disclosure contains at least a positive electrode active material and may further contain at least one of a solid electrolyte, a conductive material, and a binder, as necessary. Examples of the positive electrode active material include an oxide active material. Examples of the oxide active material include rock salt layer-type active materials, such as LiCoO₂, LiMnO₂, LiNiO₂, LiVO₂, and LiNi_{1/3}Co_{1/3}Mn_{1/3}O₂, spinel-type active materials, such as LiMn₂O₄, Li₄Ti₅O₁₂, and Li(Ni_{0.5}Mn_{1.5})O₄, and olivine-type active materials, such as LiFePO₄, LiMnPO₄, LiNiPO₄, and LiCoPO₄. The surface of the positive electrode active material may be coated with an ion conductive oxide. In a case where an ion conductive oxide is provided, it is possible to suppress the generation of a high resistance layer between the positive electrode active material and the solid electrolyte (particularly, the sulfide solid electrolyte). Examples of the ion conductive oxide include LiNbO₃. The thickness of the ion conductive oxide is, for example, 1 nm or more and 30 nm or less.

The proportion of the positive electrode active material in the positive electrode layer is, for example, 20% by volume or more, and it may be 30% by volume or more or may be 40% by volume or more. In a case where the proportion of the positive electrode active material is small, there is a possibility that the volumetric energy density is reduced. On the other hand, the proportion of the positive electrode active material is, for example, 80% by volume or less, and it may be 70% by volume or less or may be 60% by volume or less. In a case where the proportion of the positive electrode active material is large, there is a possibility that the ion conduction path and electron conduction path are not formed sufficiently.

The solid electrolyte is not particularly limited; however, examples thereof include a sulfide solid electrolyte. The details of the sulfide solid electrolyte are the same as the contents described in “A. Negative Electrode Layer” described above. The conductive material and the binder are the same as the contents described in “A. Negative Electrode Layer”. The thickness of the positive electrode layer is, for example, 0.1 μm or more and 1,000 μm or less.

3. Solid Electrolyte Layer

The solid electrolyte layer in the present disclosure is arranged between the positive electrode layer and the negative electrode layer. The solid electrolyte layer contains at least a solid electrolyte and may further contain a binder. Since the solid electrolyte and the binder are the same as the contents described in “2. Positive Electrode Layer” described above, the description thereof is omitted here. The thickness of the solid electrolyte layer is, for example, 0.1 μm or more and 1,000 μm or less.

4. All-solid State Battery

In the present disclosure, the “all-solid state battery” refers to a battery equipped with a solid electrolyte layer (at least a layer containing a solid electrolyte). Further, the all-solid state battery in the present disclosure includes a power generation element that has a positive electrode layer, a solid electrolyte layer, and a negative electrode layer. The power generation element generally has a positive electrode current collector and a negative electrode current collector. The positive electrode current collector is arranged, for example, on the surface of the positive electrode layer on a side opposite to the solid electrolyte layer. Examples of the material of the positive electrode current collector include metals, such as aluminum, SUS, and nickel. Examples of the shape of the positive electrode current collector include a foil shape and a mesh shape. On the other hand, the negative electrode current collector is arranged, for example, on the surface of the negative electrode layer on a side opposite to the solid electrolyte layer. Examples of the material of the negative electrode current collector include metals, such as copper, SUS, and nickel. Examples of the shape of the negative electrode current collector include a foil shape and a mesh shape.

The all-solid state battery in the present disclosure may include an exterior body that houses the power generation element. Examples of the exterior body include a laminate-type exterior body and a case-type exterior body. Further, the all-solid state battery in the present disclosure may be equipped with a restraining jig that applies a restraining pressure in the thickness direction to the power generation element. A known jig can be used as the restraining jig. The restraining pressure is, for example, 0.1 MPa or more and 50 MPa or less, and it may be 1 MPa or more and 20 MPa or less. In a case where the restraining pressure is small, there is a possibility that a good ion conduction path and a good electron conduction path are not formed. On the other hand, in a case where the restraining pressure is large, there is a possibility that the size of the restraining jig becomes large and thus the volumetric energy density is reduced.

The kind of the all-solid state battery in the present disclosure is not particularly limited; however, it is typically a lithium ion secondary battery. The use application of the all-solid state battery is not particularly limited. However, examples thereof include a power source for a vehicle, such as a hybrid electric vehicle (HEV), a plug-in hybrid electric vehicle (PHEV), a battery electric vehicle (BEV), a gasoline vehicle, or a diesel vehicle. In particular, it is preferably used as a power source for driving a hybrid electric vehicle, a plug-in hybrid electric vehicle, or a battery electric vehicle. Further, the all-solid state battery in the present disclosure may be used as a power source for a moving body (for example, a railway, a ship, or an aircraft) other than the vehicle or may be used as a power source for an electric product, such as an information processing device.

It is noted that the present disclosure is not limited to the embodiment. The embodiment is an example, and thus any embodiment having substantially the same configuration and having the same action or effect as the technical idea described in the claims of the present disclosure is included in the technical scope of the present disclosure.

### Example 1

Preparation of Negative Electrode Paste

First, Li₄Ti₅O₁₂ particles (LTO, specific surface area: 6.5 m²/g) were used as the negative electrode active material. The particles are referred to as LTO [A]. Next, the LTO [A] was allowed to stand overnight in an atmosphere having a dew point of −40° C. to adjust the moisture amount of the LTO [A]. A Karl Fischer titrator (MKH-710 manufactured by KYOTO ELECTRONICS MANUFACTURING Co., Ltd.) was used to determine the moisture amount of the LTO [A] by measuring the moisture amount of the LTO [A] in a case of being heated from 25° C. to 300° C.

Next, a negative electrode active material (LTO [A], density: 3.5 g/cc), a conductive material (VGCF, density: 2 g/cc), a binder (PVdF, density: 0.9 g/cc), and a dispersion medium (butyl butyrate) were weighed and mixed for 30 minutes by using an ultrasonic homogenizer (UH-50 manufactured by SMT Co., Ltd.). Then, a sulfide solid electrolyte (LiI—LiBr—Li₂S—P₂S₅-based glass ceramic, density: 2 g/cc) was added and mixed again for 30 minutes by using an ultrasonic homogenizer (UH-50, manufactured by SMT Co., Ltd.). As a result, a negative electrode paste was obtained. The composition of the negative electrode paste was, in terms of volume ratio, the negative electrode active material:the sulfide solid electrolyte:the conductive material:the binder=60.7:32.7:2.0:4.6. In addition, the amount of the dispersion medium was 1.6 g, and the solid content concentration of the negative electrode paste was 50% by mass.

Preparation of Positive Electrode Paste

As the positive electrode active material, LiNi_{1/3}Co_{1/3}Mn_{1/3}O₂ subjected to a surface treatment with LiNbO₃ was used. Then, 2.0 g of the positive electrode active material, 0.048 g of a conductive material (VGCF), 0.407 g of a sulfide solid electrolyte (LiI—LiBr—Li₂S—P₂S₅-based glass ceramic), 0.016 g of a binder (PVdF), and 1.3 g of a dispersion medium (butyl butyrate) were weighed and mixed by using an ultrasonic homogenizer (UH-50 manufactured by SMT Co., Ltd.). As a result, a positive electrode paste was obtained.

Preparation of Paste for SE Layer

A dispersion medium (heptane), a binder (a heptane solution containing 5% by mass of a butadiene rubber-based binder), and a sulfide solid electrolyte (LiI—LiBr—Li₂S—P₂S₅-based glass ceramic, average particle diameter D₅₀: 2.5 μm) were added in a polypropylene container and mixed for 30 seconds by using an ultrasonic homogenizer (UH-50, manufactured by SMT Co., Ltd.). Next, the container was shaken with a shaker for 3 minutes. As a result, a paste for a solid electrolyte layer (a paste for an SE layer) was obtained.

Production of All-solid State Battery

First, the positive electrode paste was applied onto a positive electrode current collector (an aluminum foil) by a blade method using an applicator. After coating, drying was carried out on a hot plate at 100° C. for 30 minutes. As a result, a positive electrode having a positive electrode current collector and a positive electrode layer were obtained. Next, the negative electrode paste was applied onto a negative electrode current collector (a copper foil). After coating, drying was carried out on a hot plate at 100° C. for 30 minutes. As a result, a negative electrode having a negative electrode current collector and a negative electrode layer were obtained. Here, the weight per unit area of the negative electrode layer was adjusted so that the specific charging capacity of the negative electrode was 1.15 times in a case where the specific charging capacity of the positive electrode is set to 185 mAh/g.

Next, the positive electrode was pressed. The surface of the positive electrode layer after pressing was coated with the SE layer paste using a die coater and dried on a hot plate at 100° C. for 30 minutes. Then, roll pressing was carried out at a linear pressure of 2 tons/cm. As a result, a positive electrode side laminate having a positive electrode current collector, a positive electrode layer, and a solid electrolyte layer was obtained. Next, the negative electrode was pressed. The surface of the negative electrode layer after pressing was coated with the SE layer paste using a die coater and dried on a hot plate at 100° C. for 30 minutes. Then, roll pressing was carried out at a linear pressure of 2 tons/cm. As a result, a negative electrode side laminate including a negative electrode current collector, a negative electrode layer, and a solid electrolyte layer was obtained.

The positive electrode side laminate and the negative electrode side laminate were each subjected to punch processing and arranged so that the solid electrolyte layers faced each other, and an unpressed solid electrolyte layer was arranged between the positive electrode side laminate and the negative electrode side laminate. Then, roll pressing was carried out at 130° C. with a linear pressure of 2 tons/cm to obtain a power generation element having a positive electrode, a solid electrolyte layer, and a negative electrode in this order. The obtained power generation element was laminated and enclosed and then restrained at 5 MPa to obtain an all-solid state battery.

### Examples 2 to 4 and Comparative Examples 1 and 2

An all-solid state battery was obtained in the same manner as in Example 1 except that the moisture amount of the LTO [A] was changed to the value shown in Table 1. In Examples 2 to 4, LTO [A] was dried in advance under the conditions of a vacuum atmosphere (negative pressure gauge: −0.1 MPa to 0 MPa) and a drying temperature of 200° C. to 300° C. The moisture amount of the LTO [A] was adjusted by the drying time. In addition, in Comparative Example 1, the moisture amount of the LTO [A] was adjusted by allowing the LTO [A] to stand overnight in the air atmosphere at normal temperature without drying it in advance.

### Examples 5 and 6 and Comparative Example 3

Li₄Ti₅O₁₂ particles (LTO, specific surface area: 3.9 m²/g, density: 3.4 g/cc) were used as the negative electrode active material. The particles are referred to as LTO [B]. An all-solid state battery was obtained in the same manner as in Example 1 except that the LTO [B] was used and the moisture amount thereof was changed to the value shown in Table 2.

### Comparative Examples 4 to 6

An all-solid state battery was obtained in the same manner as in Example 1 except that hard carbon (HC, specific surface area: 4.5 m²/g, density: 2 g/cc) was used as the negative electrode active material and the moisture amount thereof was changed to the value shown in Table 3.

Evaluation

Measurement of Specific Surface Area

The specific surface area of the negative electrode active material was measured in accordance with the JIS standard, “JIS R 1626: 1996 Measuring method for specific surface area of fine ceramic powder by gas adsorption BET method”.

Density Measurement

The density of the negative electrode active material, the conductive material, the binder and the sulfide solid electrolyte was measured in accordance with JIS standard, “JIS R1620: 1995 Measuring method for particle density of fine ceramic powder”.

Measurement of Direct Current Resistance

The direct current resistance of the all-solid state batteries produced in Examples 1 to 6 and Comparative Examples 1 to 6 was specified. Specifically, each all-solid state battery was charged at a constant current mode with a current equivalent to 1 C, charged at a constant voltage mode after the cell voltage reached 2.95 V, and then the charging was terminated at the time in a case where the charging current reached a value equivalent to 0.01 C. Then, it was discharged at a constant current mode with a current equivalent to 1 C, and the discharging was terminated at the time in a case where the voltage reached 1.5 V. Then, the all-solid state battery was charged at a constant current mode with a current equivalent to 3 C, and the difference between the voltage before charging and the voltage after charging for 10 seconds was divided by the current equivalent to 3 C to calculate the direct current resistance (the charging resistance). The results are shown in Tables 1 to 3 and FIG. 2. It is noted that the value of the charging resistance ratio in Table 1 is a relative value with respect to Comparative Example 2, the value of the charging resistance ratio in Table 2 is a relative value with respect to Comparative Example 3, and the value of the charging resistance ratio in Table 3 is a relative value with respect to Comparative Example 4.

TABLE 1

| | | | Charging resistance |
|---|---|---|---|
| | Negative electrode | Moisture amount | ratio |
| | active material | (ppm) | (relative value) |
| Comparative | LTO [A] | 3059 | 0.99 |
| Example 1 | | | |
| Example 1 | LTO [A] | 547 | 0.94 |
| Example 2 | LTO [A] | 353 | 0.93 |
| Example 3 | LTO [A] | 53 | 0.95 |
| Example 4 | LTO [A] | 25 | 0.94 |
| Comparative | LTO [A] | 5 | 1 |
| Example 2 | | | |

TABLE 2

| | | | Charging resistance |
|---|---|---|---|
| | Negative electrode | Moisture amount | ratio |
| | active material | (ppm) | (relative value) |
| Example 5 | LTO [B] | 412 | 0.93 |
| Example 6 | LTO [B] | 82 | 0.95 |
| Comparative | LTO [B] | 10 | 1 |
| Example 3 | | | |

TABLE 3

| | | | Charging resistance |
|---|---|---|---|
| | Negative electrode | Moisture amount | ratio |
| | active material | (ppm) | (relative value) |
| Comparative | HC | 872 | 1 |
| Example 4 | | | |
| Comparative | HC | 412 | 0.99 |
| Example 5 | | | |
| Comparative | HC | 142 | 0.98 |
| Example 6 | | | |

As shown in Table 1 and FIG. 2, it was confirmed that Examples 1 to 4 have a low charging resistance ratio as compared with Comparative Examples 1 and 2. It is presumed that the reason why the charging resistance ratio of Example 1 is low as compared with Comparative Example 1 is that the deterioration of the sulfide solid electrolyte (the generation of a high resistance layer) has been suppressed. On the other hand, it is presumed that the reason why the charging resistance ratio of Example 4 is low as compared with Comparative Example 2 is that the presence of an appropriate amount of the moisture on the surface of the lithium titanate improves the affinity between the lithium titanate and the sulfide solid electrolyte. Similarly, as shown in Table 2 and FIG. 2, it was confirmed that Examples 5 and 6 have a low charging resistance ratio as compared with Comparative Example 3. On the other hand, as shown in Table 3 and FIG. 2, it was confirmed that in the case of hard carbon, the moisture amount does not significantly affect the charging resistance ratio as shown in Comparative Examples 4 to 6.

What is claimed is:

1. A negative electrode layer that is used in an all-solid state battery, the negative electrode layer comprising:
lithium titanate; and
a sulfide solid electrolyte,
wherein an amount of moisture contained in the lithium titanate is 25 ppm or more and 547 ppm or less.

2. The negative electrode layer according to claim 1, wherein the lithium titanate has a composition represented by Li₄Ti₅O₁₂.

3. The negative electrode layer according to claim 1, wherein a specific surface area of the lithium titanate is 3.9 m²/g or more and 6.5 m²/g or less.

4. The negative electrode layer according to claim 1, wherein the sulfide solid electrolyte contains Li, P, and S.

5. The negative electrode layer according to claim 1, wherein a proportion of the lithium titanate to a total of the lithium titanate and the sulfide solid electrolyte is 40% by volume or more and 80% by volume or less.

6. An all-solid state battery comprising:
a positive electrode layer;
the negative electrode layer according to claim 1; and
a solid electrolyte layer arranged between the positive electrode layer and the negative electrode layer.
